(19) United States
(12) Patent Application Publication
(10) Pub. No.: US 2005/0264233 A1
(43) Pub. Date: Dec. 1, 2005

(54) Plasma display panel (PDP)

(76) Inventor: Kyu-Hang Lee, Suwon-si (KR)

Correspondence Address: Robert E. Bushnell;Suite 300, 1522 K Street, N.W., Washington, DC, 20005-1202, US

(21) Appl. No.: 11/133,340

(22) Filed: May 20, 2005

(30) Foreign Application Priority Data
May 25, 2004 (KR) 10-2004-0037306
Jun. 30, 2004 (KR) 10-2004-0050687

(51) Int. Cl. G09G 3/28

(52) U.S. Cl. 315/169.4

(57) ABSTRACT

A Plasma Display Panel (PDP) includes: a front substrate and a rear substrate opposing each other; barrier ribs positioned between the front and second substrates to define a plurality of discharge cells; address electrodes arranged to correspond to the discharge cells; phosphor layers arranged in each of the discharge cells to define the discharge cells into discharge cells of first, second, and third colors; and scan electrodes and sustain electrodes intersecting the address electrodes and opposing each other in each of the discharge cells and adapted to form discharge gaps. The scan electrodes and sustain electrodes extend along one direction intersecting the address electrodes, each including line sections spaced apart from one another, and a pair of connecting portions are arranged in least one color discharge cell adjacent to a pair of barrier ribs defining the least one color discharge in a direction intersecting the line sections.

### CLAIM OF PRIORITY

This application makes reference to, incorporates the same herein, and claims all benefits accruing under 35 U.S.C. § 119 from my two applications entitled PLASMA DISPLAY PANEL, earlier filed in the Korean Intellectual Property Office on 25 May 2004 and 30 Jun. 2004, and there duly assigned Serial Nos. 10-2004-0037306 and 10-2004-0050687, respectively.

### BACKGROUND OF THE INVENTION

1. Field of the Invention

The present invention relates to a Plasma Display Panel (PDP), and more particularly, to a PDP with increased brightness by improving an electrode structure.

2. Description of the Related Art

In general, a PDP is a display device using visible light that is generated when ultraviolet rays generated by the discharge of gas excite phosphors, thereby realizing desired images. The PDP enables a large-scale screen of more than 60 inches with a thickness of less than 10 cm (centimeters). In addition, since the PDP is a self-emission-type display device, like a cathode ray tube (CRT), it exhibits satisfactory color reproduction without distortion due to viewing angle. Furthermore, its manufacturing process is simpler than that of a liquid crystal X display (LCD), so that the PDP is advantageous from the viewpoints of productivity and cost. Accordingly, the PDP has been highlighted for televisions and flat panel displays for industrial purposes.

Many structures for PDPs have been suggested over a long period of time since the 1970's, and a three-electrode surface discharge type is a major player in the current PDP structures. A three-electrode surface discharge PDP includes a front substrate having electrode pairs, a rear substrate spaced a predetermined distance apart from the front substrate and having address electrodes extending in a vertical direction, and a space disposed between the front substrate and the rear substrate discharge sealed with discharge gas. Discharge generally occurs by accumulation of wall charges, which is performed by address electrodes, and sustain-discharge for brightness display is achieved by a plurality of electrode pairs provided on a front substrate. Transparent material such as indium tin oxide (ITO) is typically used for the conventional discharge sustain electrodes. That is, the conventional discharge sustain electrodes are typically transparent electrodes. This transparency allows visible light generated in the discharge cells to pass through the discharge sustain electrodes while the discharge sustain electrodes perform their function of effecting sustain discharge.

In order to prevent light emitted from a front substrate from being blocked, electrodes are typically formed by transparent electrodes, thereby allowing the light to pass through the transparent electrodes. Here, since the transparent electrodes are highly resistive, they are generally used in combination with a metal electrode in order to compensate for its conductivity. In this case, to avoid light emitted from discharge cells from being blocked due to the metal electrode that incapable of transmitting light, the metal electrode is formed along the periphery in a width direction of the transparent electrode.

Even though the transparent electrode and the metal electrode operate, since the transparent electrodes are located around a discharge gap where discharge substantially occurs, a considerably high priming voltage is required for initiating the discharge. In addition, since a material forming the transparent electrode, for example, ITO, is expensive, the production cost of a PDP is quite high, thereby impairing cost competitiveness. Also, since strip-type electrodes formed on a substrate are double layers consisting of a transparent electrode and a metal electrode, a manufacturing process becomes complicated, resulting in an increase in the production cost.

Since discharges occurring in discharge cells are induced by a dielectric layer, phosphor layers and discharge gas provided between address electrodes and electrodes provided on the front substrate, characteristics of these constituent materials and shapes greatly affect on the discharges. Specifically, as to the dielectric layer, since the dielectric layer is formed over the entire surface of the substrate to a substantially uniform thickness, there is little difference in the characteristics between each of red, green and blue discharge cells.

However, with regard to the phosphor layers, they exhibit different dielectric constants for the respective colors. The phosphor layers are made of a blue phosphor such as europium-based barium magnesium aluminate (BaMgAl₁₀O₁₇:Eu), a green phosphor such as manganese-based zinc silicate (Zn₂SiO₄:Mn) or (BaAl₁₂O₁₉:YBO₃:Tb), and a red phosphor such as europium-based yttrium gadolinium borate (Y_{0.35}Gd_{0.35}BO₃) or (Y₂O₃:EU, Gd₂O₃:Eu). In addition, when PDPs are practically produced, there is a difference in the thickness between each of different color phosphor layers. Thus, a difference in the capacitance is created due to a difference in the material characteristic and thickness between each of the phosphor layers, resulting in different brightness characteristics for the respective red, green and blue discharge cells. In particular, if the brightness of a blue discharge cell becomes relatively lowered, the color temperature (or white balance) is reduced accordingly. In such a case, the brightness of the PDP is undesirably perceived by the human visual system to be at a relatively low level. Thus, it is necessary to adjust white balance in a circuit manner through gamma correction. In this case, since blue brightness is relatively low, the white balance is adjusted on the basis of the blue brightness. Therefore, a loss in the brightness corresponding to a difference between blue brightness and red (or green) brightness is generated by the gamma correction.

In a three-electrode surface discharge PDP, the electrodes extend along one direction and the barrier ribs extend along the other direction. In such a PDP, the brightness increases as the electrodes come closer to a discharge gap and barrier ribs.

### SUMMARY OF THE INVENTION

One object of the present invention is to provide a PDP with increased brightness by improving an electrode structure.

Another object of the present invention is to provide a PDP with increased brightness by improving an electrode structure to reduce a brightness difference between different color discharge cells.

These and other objects can be achieved by providing a Plasma Display Panel (PDP) comprising: a front substrate and a rear substrate opposing each other; barrier ribs positioned between the front and second substrates to define a plurality of discharge cells; address electrodes corresponding to the discharge cells; phosphor layers arranged in each of the discharge cells; and scan electrodes and sustain electrodes intersecting the address electrodes and opposing each other within the discharge cells and adapted to form discharge gaps; wherein the scan electrodes and sustain electrodes each include first line sections extending along one direction intersecting the address electrodes, second line sections spaced apart from the first line sections and positioned within the discharge cells to form the discharge gaps, and connecting portions adjacent to the barrier ribs intersecting the first and second line sections and adapted to connect the first line sections to the second line sections.

The connecting portions are preferably provided in pairs adjacent to a pair of barrier ribs defining the discharge cells in a direction intersecting the first line sections and the second line sections.

The connecting portions are preferably spaced apart 40 to 50 μm from wall surfaces of the barrier ribs.

The connecting portions are preferably spaced apart 10 to 20 μm from the phosphor layers arranged on the barrier ribs.

The PDP preferably further comprises third line sections arranged between the first line sections and the second line sections.

The first, second, and third line sections are preferably parallel with one another.

The discharge gaps preferably include a first gap member and a second gap member, the first and second gap members preferably having different lengths from each other.

The second gap member is preferably longer than the first gap member and is preferably arranged at intersections where the second line sections and the connecting portions meet.

The first and line sections and the connecting portions preferably comprise thin, long strip-shaped thin films.

The first and line sections and the connecting portions preferably comprise chrome, copper or other metallic materials.

These and other objects can also be achieved by providing a Plasma Display Panel (PDP) comprising: a front substrate and a rear substrate opposing each other; barrier ribs positioned between the front and second substrates to define a plurality of discharge cells; address electrodes arranged to correspond to the discharge cells; phosphor layers arranged in each of the discharge cells to define the discharge cells into discharge cells of first, second, and third colors; and scan electrodes and sustain electrodes intersecting the address electrodes and opposing each other in each of the discharge cells and adapted to form discharge gaps; wherein the scan electrodes and sustain electrodes extend along one direction intersecting the address electrodes, each including a plurality of line sections spaced apart from one another, and a pair of connecting portions arranged in least one color discharge cell adjacent to a pair of barrier ribs defining the least one color discharge in a direction intersecting the plurality of line sections.

The plurality of line sections formed along the third color discharge cell are preferably connected to one another through the pair of connecting portions.

The plurality of line sections formed along the first and second color discharge cells are preferably connected to one another through one connecting portion.

The connecting portions formed along the first and second color discharge cells are preferably positioned toward the centers of the discharge cells.

The connecting portions are preferably spaced apart 40 to 50 μm from the phosphor layers arranged on the barrier ribs.

The connecting portions are preferably spaced apart 10 to 20 μm from the phosphor layers arranged on the barrier ribs.

The scan electrodes and sustain electrodes each preferably include first line sections extending along a direction intersecting the address electrodes, and second line sections spaced apart from the first line sections and positioned in each of the discharge cells to form the discharge gaps.

The PDP preferably further comprises third line sections arranged between the first line sections and the second line sections.

The first, second, and third line sections are preferably parallel to one another.

The discharge gaps preferably include a first gap member and a second gap member, the first and second gap members preferably having different lengths from each other.

The second gap member is preferably longer than the first gap member and preferably arranged at interconnections where the second line sections and the connecting portions meet.

The first and line sections and the connecting portions preferably comprise thin, long strip-like thin films.

The first and line sections and the connecting portions preferably comprise chrome, copper or other metallic materials.

The first, second, and third colors respectively preferably comprise red, green, and blue.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of distributions of brightness for discharge cells in a three-electrode surface discharge PDP;

FIG. 2 is a partial exploded perspective view of a PDP according to a first exemplary embodiment of the present invention;

FIG. 3 is a schematic plan view of an arrangement of electrodes and barrier ribs of the PDP of FIG. 2;

FIG. 4 is a schematic plan view of an arrangement of electrodes and barrier ribs according to a modification of the first exemplary embodiment of the present invention;

FIG. 5 is a partial exploded perspective view of a PDP according to a second exemplary embodiment of the present invention;

FIG. 6 is a schematic plan view of an arrangement of electrodes and barrier ribs of the PDP of FIG. 5;

FIG. 7 is a schematic plan view of an arrangement of electrodes and barrier ribs according to a modification of the second exemplary embodiment of the present invention.

### DETAILED DESCRIPTION OF THE INVENTION

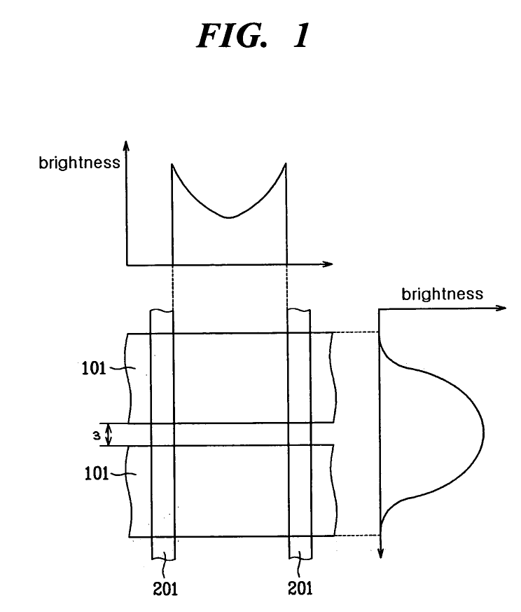

FIG. 1 is a view of a brightness distribution for a discharge cell in a three-electrode surface discharge PDP, in which only electrodes 101 and barrier ribs 201 are selectively shown. In FIG. 1, the electrodes 101 extend along one direction (in a vertical direction of the drawing) and the barrier ribs 201 extend along the other direction (in a horizontal direction of the drawing). As shown in FIG. 1, the brightness increases as the electrodes 101 come closer to a discharge gap w and barrier ribs 201.

In the following detailed description, exemplary embodiments of the present invention have been shown and described simply by way of illustration. As will be understood by a person skilled in the art, the illustrated embodiments of the present invention can be modified or altered in various respects, all without departing from the scope of the present invention. Accordingly, the drawings and description are to be regarded as illustrative in nature, rather than restrictive.

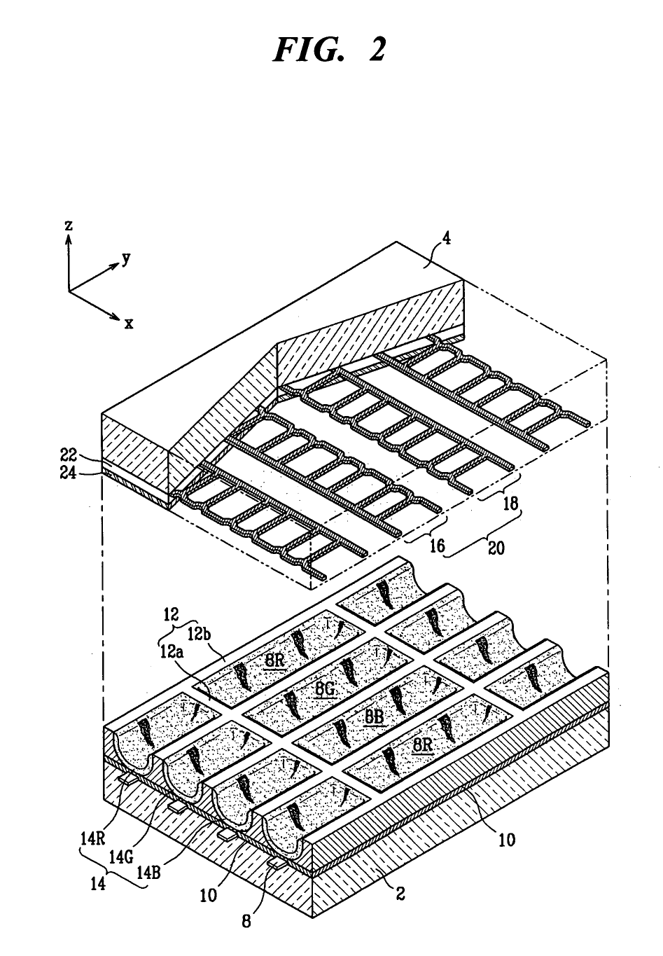

Referring to FIG. 2, a PDP according to a first exemplary embodiment of the present invention includes a front substrate 4 and a rear substrate 2 opposing and spaced a predetermined distance apart from each other, and discharge cells 8R, 8G and 8B for Red (R), Green (G) and Blue (b) colors, defined by barrier ribs 12 in a space between the first and the second substrates 2 and 4. An address electrode 8 is preferably arranged in parallel to adjacent address electrodes 8, and the address electrodes 8 are separated from one another by a predetermined distance, extending along a direction (in the y-axis direction of the drawing) intersecting a width direction (in the x-axis direction of the drawing) of the discharge cells 8R, 8G and 8B.

The address electrodes 8 are formed on an inner surface of the rear substrate 2, and a dielectric layer 10 is formed over the entire surface of the inner surface of the rear substrate 2 and covering the address electrodes 8.

The barrier ribs 12 are formed on the dielectric layer 10, and red, green, and blue phosphors 14R, 14G and 14B are then coated over the dielectric layer 10, that is, on sidewalls and bottom surface of the barrier ribs 12, to form discharge cells 8R, 8G and 8B for the respective colors.

In FIG. 2, the discharge cells 8R, 8G and 8B are arranged in a matrix pattern in which the barrier ribs 12 include horizontal barrier ribs 12a formed along the x-axis direction of the drawing and vertical barrier ribs 12b formed along the y-axis direction of the drawing. However, the present invention is not limited thereto. For instance, discharge cells according to the present invention can have a stripe pattern in which the barrier ribs 12 include only second barrier ribs 12b parallel to one another, or a delta pattern having a triangular configuration.

Display electrodes 20 having scan electrodes 16 and sustain electrodes 18 are formed along an intersecting direction (x-axis direction of the drawing) with respect to the address electrodes 8 on the front substrate 4 opposing the rear substrate 2. A dielectric layer 22 and a protective layer 24 are then sequentially formed over the entire surface of an inner surface of the front substrate 4 and covering the display electrodes 20.

In the illustrative embodiment of FIG. 2, the display electrodes 20 are of a metallic conductive material and have a hollow structure. Structures of the display electrodes 20 according to this embodiment are described below in greater detail.

The address electrodes 8 and the display electrodes 20 are disposed to cross one another in the discharge cells 8R, 8G and 8B by a combination of the front substrate 4 and the rear substrate 2, and the insides of the discharge cells 8R, 8G and 8B are filled with discharge gases (typically Ne—Xe mixture gas) to induce emission of UV rays when excited by a plasma discharge.

The structures of the display electrodes 20 according to the first embodiment are described in detail below with reference to the accompanying drawings, in which the display electrodes 20 are formed by a combination of a plurality of line sections of metal electrodes.

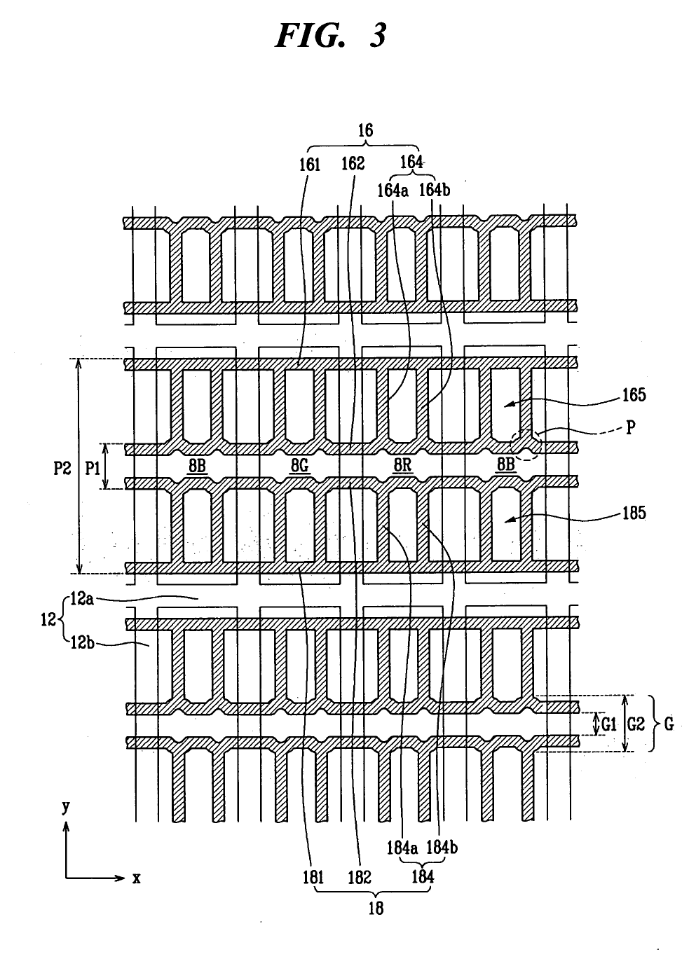

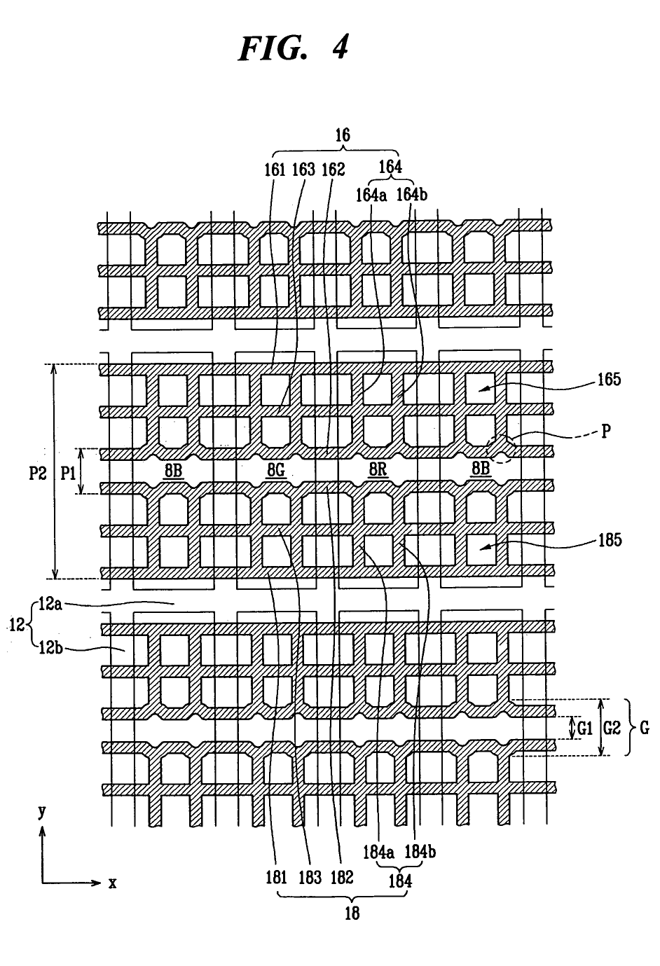

FIGS. 3 and 4 are views of the display electrodes 20 formed in the respective discharge cells in a matrix pattern. In the following description, matrix type discharge cells are discussed. However, the present invention is not limited thereto.

In the illustrative embodiment, each scan electrode 16 and sustain electrode 18 includes first line sections 161 and 181 formed in the discharge cells in the vicinity of the horizontal barrier ribs 12a, and second line sections 162 and 182 facing each other within the discharge cells to form a discharge gap G.

In more detail, the first line sections 161 and 181 extend in an elongated direction of the horizontal barrier ribs 12a (in the x-axis direction of the drawing) and are positioned within the discharge cells in the vicinity of the horizontal barrier ribs 12a. Thus, the first line sections 161 and 181 are positioned toward the insides of the discharge cells in the vicinity of the horizontal barrier ribs 12a and extend in one direction (in the x-axis direction of the drawing). Accordingly, the first line section 161 of the scan electrode 16 and the first line section 181 of the sustain electrode 18 are farthest away from each other while facing each other.

In the following description, second line sections, third line sections and connecting portions, including the first line sections 161 and 181, are formed of strip-shaped thin films of a metallic material such as chrome or copper.

The second line sections 162 and 182 having the same shape as the first line sections 161 and 181 can further be provided within the discharge cells in the vicinity of the first line sections 161 and 181. The second line sections 162 and 182 of the scan electrodes 16 and sustain electrodes 18 are provided in the discharge cells, respectively, to face each other with a predetermined distance therebetween, the predetermined distance being shorter than a distance between the facing first line sections 161 and 181.

The second line sections 162 and 182 are spaced a predetermined distance apart from the first line sections 161 and are formed inside the discharge cells. Thus, open spaces are produced between each of the first line sections 161 and 181 and the second line sections 162 and 182.

In addition, connecting portions 164 and 184 can be further provided to connect the first line sections 161 and 181 to the second line sections 162 and 182 within a unit discharge cell, thereby respectively forming a scan electrode 16 and a sustain electrode 18. The connecting portions 164 and 184 are formed in pairs 164a/164b, and 184a/184b, to correspond to a pair of vertical barrier ribs 12b defining one discharge cell.

In practice, the first line sections 161 and 181 and the second line sections 162 and 182 form a closed loop within the discharge cell with the connecting portions 164 and 184, and openings 165 and 185 are formed therein accordingly. Since the openings 165 and 185 prevent light from being interfered with when the light is output from the discharge cell, the aperture ratio of the PDP is increased, thereby improving the brightness of the PDP.

In addition, the connecting portions 164 and 184 increase the probability of distribution states of wall charges, allowing discharge P1 in the discharge gap G between the second line sections 162 and 182 to expand to the first line sections 161 and 181, thereby easily forming surface discharge P2 with a long discharge path. In the PDP, the plasma discharge is driven using a glow discharge as main discharge. Thus, with the configuration of the connecting portions 164 and 184, a ‘positive column’ is formed by the surface discharge, thereby increasing discharge efficiency.

Similarly, in the illustrative embodiment, the discharge gap G is preferably formed by a first gap member G1 that is relatively short and a second gap member G2 longer than the first gap member G1. In particular, the second gap member G2 is preferably formed at an intersection P where each of the connecting portions 164 and 184 and each of the second line sections 162 and 182 meet. With this configuration, the discharge induced in the first gap member G1 can be easily induced to the surface discharge occurring between the first line sections 161 and 181 through the connecting portions 164 and 184.

Referring to FIG. 3, to form the first gap member G1 and the second gap member G2, concave portions opposing each other are formed at intersections P.

FIG. 4 is a view of an electrode structure further comprising third line sections between the first line sections and the second line sections.

An electric field formed between line sections induces a discharge that is inversely proportional to the distance therebetween. Accordingly, if a distance between each of the first line sections 161 and 181 and each of the second line sections 162 and 182 is overly long, the discharge initiated by the first gap member G1 can not be induced to the surface discharge occurring between the first line sections 161 and 181. With this configuration, the distance between each of the first line sections 161 and 181 and each of the second line sections 162 and 182 is reduced by the third line sections 163 and 183, thereby allowing a surface discharge to easily occur.

The third line sections 163 and 183 are positioned between each of the first line sections 161 and 181 and each of the second line sections 162 and 182 and extend in parallel with one another in one direction (in the x-axis direction of the drawing).

Since the first line sections 161 and 181 and the second line sections 162 and 182 are interconnected in their respective discharge cells, even when one of line sections is disconnected, the disconnected section can be compensated for by the other section, which can also serve as an positive factor of increasing luminous efficiency and brightness of a PDP.

As previously confirmed in FIG. 1, the closer that the barrier ribs are to the wall, the higher the brightness becomes. Based on this understanding, a method of determining appropriate positions of the connecting portions 164 and 184 in this illustrative embodiment is described below.

The connecting portions 164 and 184 are formed in pairs in the vicinity of a pair of vertical barrier ribs 12b defining discharge cells. The connecting portions 164 and 184 are preferably spaced a predetermined distance apart from the barrier ribs 12b. Experimentally, the connecting portions 164 and 184 are preferably spaced apart 10 to 20 μm from phosphor layers formed on wall surfaces of the barrier ribs 12b. If a space in which the connecting portions 164 and 184 are separated from the phosphor layers is smaller than the range stated above, the shortage can give rise to shielding of light. If the space in which the connecting portions 164 and 184 are separated from the phosphor layers exceeds the range stated above, the excess can disable phosphors to be excited.

In consideration of processing conditions, the phosphor layers are preferably coated to a thickness of approximately 30 μm. Thus, the connecting portions 164 and 184 are preferably spaced apart 40 to 50 μm from the barrier ribs.

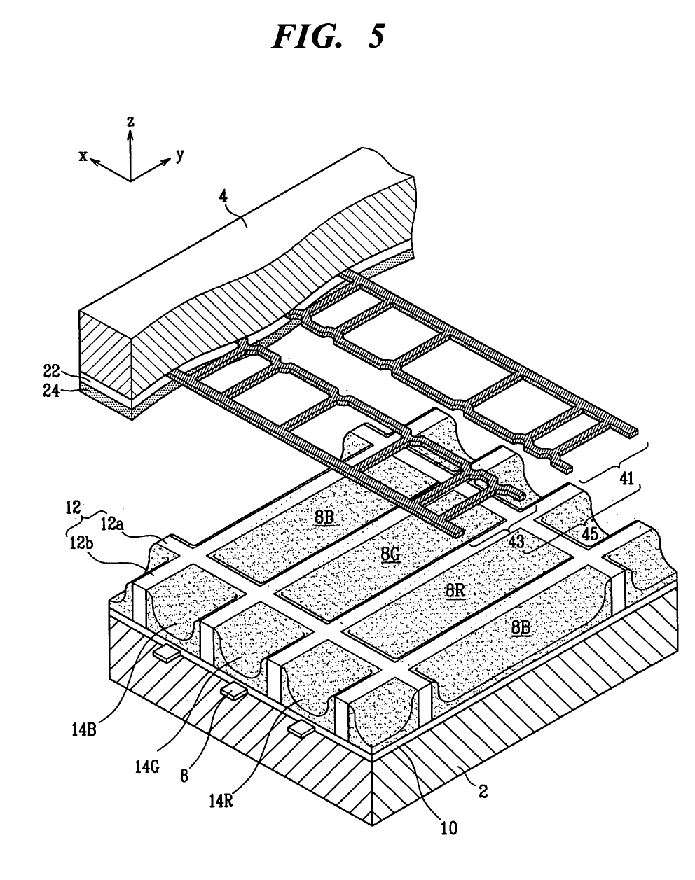

A second exemplary embodiment of the present invention is described in detail below with reference to the accompanying drawings. FIGS. 5 through 7 illustrate a PDP and discharge cells according to the second exemplary embodiment of the present invention. The same functional components as those in the first exemplary embodiment are identified by the same reference numerals, and a detailed explanation thereof has been omitted.

The PDP according to the second exemplary embodiment of the present invention is similar to that according to the first exemplary embodiment of the present invention in that display electrodes 45 are formed by a pair of a plurality of line sections. However, the PDP according to the second exemplary embodiment of the present invention has different electrode structures of discharge cells for colors, thereby compensating for a brightness difference between each of the discharge cells, which is described below in more detail with reference to the accompanying drawings.

In the illustrative embodiment, the display electrodes 45 include scan electrodes 41 and sustain electrodes 43 opposing each other in each discharge cell. Each of the scan electrode 41 and the sustain electrodes 43 are formed by a combination of a plurality of line sections.

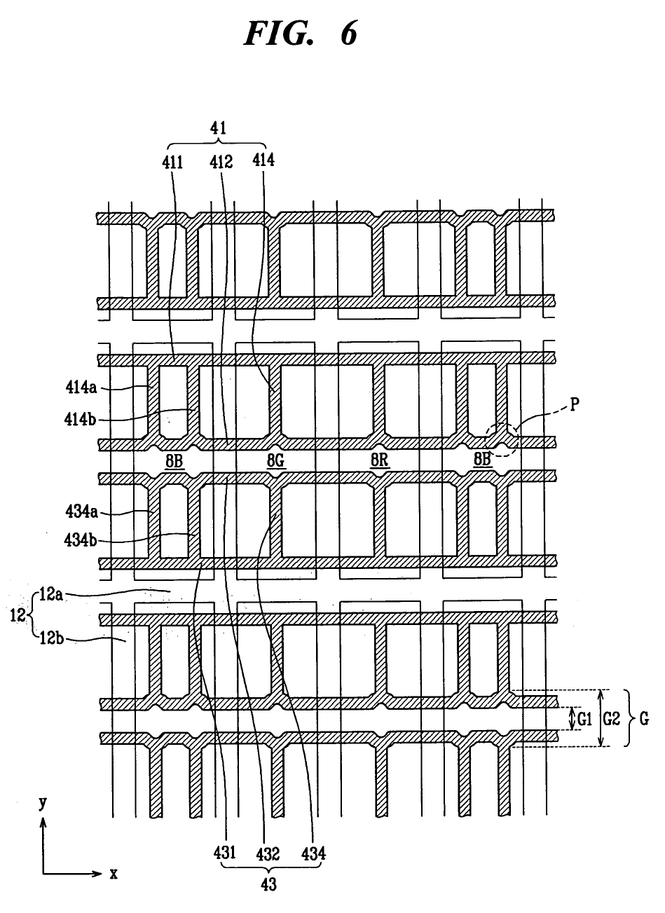

As shown in FIG. 6, each of the scan electrodes 41 and the sustain electrodes 43 include first line sections 411 and 431 adjacent to the horizontal barrier ribs 12a and second line sections 412 and 432 spaced apart from the first line sections 411 and 431 and formed inside the discharge cell. The second line sections 412 and 432 face each other inside the discharge cell, forming a discharge gap G, and forming an opposed discharge at an initial discharge stage according to a voltage pulse supplied to each electrode.

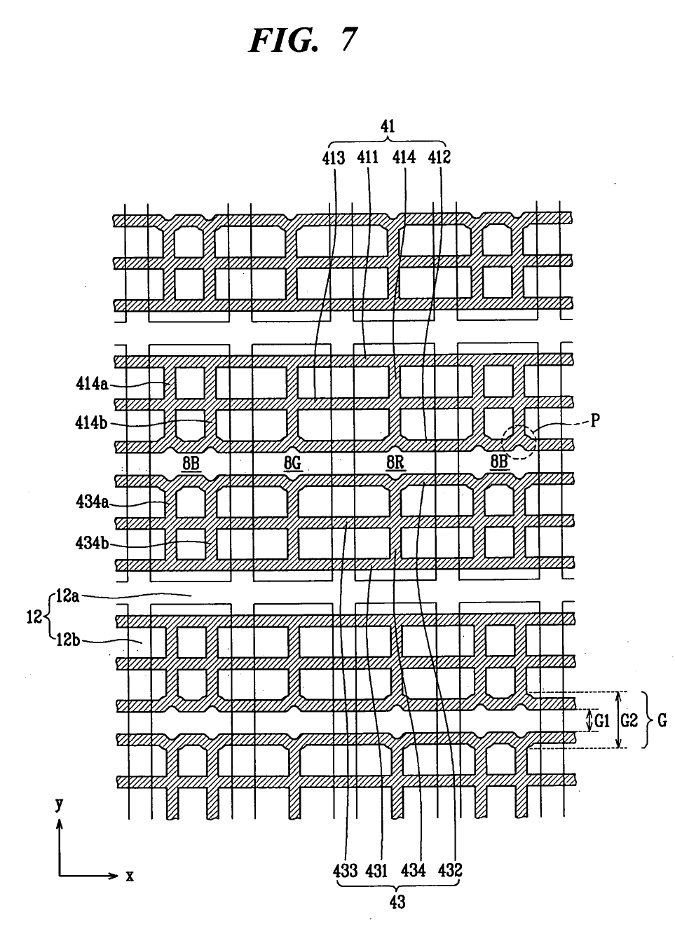

The opposed discharge of the initial discharge stage spreads between the first line sections 411 and 431 to induce a surface discharge. If spaces between the first line sections 411 and 431 and between the second line sections 412 and 432 are too wide, a discharge can not spread. Thus, third line sections 413 and 433 for inducing spreading of the discharge can further be provided between the line sections 411 and 431 and between the second line sections 412 and 432 (see FIG. 7).

Selectively, connecting portions 414 and 434 can further be formed on each discharge cell. That is, for a discharge cell having the lowest brightness, a pair of connecting portions can further be formed. While it has been shown and illustrated that a blue discharge cell has the lowest brightness, the present invention is not limited thereto.

As the electrode becomes closer to the barrier ribs, the brightness increases, which has been previously described in FIG. 1. Based on this finding, in this embodiment, for the blue discharge cell having the lowest brightness, pairs 414a/414b and 434a/434b of connecting portions 414 and 434 are arranged in the vicinity of vertical barrier ribs 12b defining discharge cells, while for red and green discharge cells, connecting portions are arranged along a width direction of the discharge cells (in the x-axis direction of the drawing).

The connecting portions 414 and 434 provide a path through which charges generated by a plasma discharge migrate. The connecting portions 414a, 414b, 434a and 434b are arranged in the vicinity of wall surfaces of the vertical barrier rib 12b, thereby increasing the probability of charges distributed around the vertical barrier ribs 12. As a result, the probability of phosphors excited at the vertical barrier ribs 12 is increased, ultimately increasing the brightness of the blue discharge cell 8B.

With regard to a red or green discharge cell 8R and 8G, one connecting portion is formed around the center of the pertinent discharge cell. Thus, a difference in the brightness between the blue discharge cell and the red (or green) discharge cell is reduced, allowing white balance to be adjusted while reducing a relatively small brightness level of the red or green discharge cell, thereby enhancing the brightness of a PDP.

As described above, in comparison to the conventional combination electrode panel, the PDP according to the present invention can reduce manufacturing costs, and reduce a driving voltage necessary for a sustain discharge by reinforcing the intensity of the sustain discharge. In addition, since the PDP according to the present invention forms a sustain discharge over a wider area in discharge cells, a stabilized sustain discharge can be achieved while improving the luminous efficiency of the PDP. Moreover, a difference in the brightness between each of different color discharge cells can be considerably reduced.

Although the present invention has been explained by the embodiments shown in the drawings described above, it should be understood to a person of ordinary skill in the art that the present invention is not limited to these embodiments, but rather that various changes or modifications thereof are possible without departing from the spirit of the present invention. Accordingly, the scope of the present invention shall be determined only by the appended claims.

1. A Plasma Display Panel (PDP), comprising:
a front substrate and a rear substrate opposing each other;
barrier ribs positioned between the front and second substrates to define a plurality of discharge cells;
address electrodes corresponding to the discharge cells;
phosphor layers arranged in each of the discharge cells; and
scan electrodes and sustain electrodes intersecting the address electrodes and opposing each other within the discharge cells and adapted to form discharge gaps;
wherein the scan electrodes and sustain electrodes each include first line sections extending along one direction intersecting the address electrodes, second line sections spaced apart from the first line sections and positioned within the discharge cells to form the discharge gaps, and connecting portions adjacent to the barrier ribs intersecting the first and second line sections and adapted to connect the first line sections to the second line sections.

2. The PDP of claim 1, wherein the connecting portions are provided in pairs adjacent to a pair of barrier ribs defining the discharge cells in a direction intersecting the first line sections and the second line sections.

3. The PDP of claim 1, wherein the connecting portions are spaced apart 40 to 50 μm from wall surfaces of the barrier ribs.

4. The PDP of claim 1, wherein the connecting portions are spaced apart 10 to 20 μm from the phosphor layers arranged on the barrier ribs.

5. The PDP of claim 1, further comprising third line sections arranged between the first line sections and the second line sections.

6. The PDP of claim 5, wherein the first, second, and third line sections are parallel with one another.

7. The PDP of claim 1, wherein the discharge gaps include a first gap member and a second gap member, the first and second gap members having different lengths from each other.

8. The PDP of claim 7, wherein the second gap member is longer than the first gap member and is arranged at intersections where the second line sections and the connecting portions meet.

9. The PDP of claim 1, wherein the first and line sections and the connecting portions comprise thin, long strip-shaped thin films.

10. The PDP of claim 1, wherein the first and line sections and the connecting portions comprise chrome, copper or other metallic materials.

11. A Plasma Display Panel (PDP), comprising:
a front substrate and a rear substrate opposing each other;
barrier ribs positioned between the front and second substrates to define a plurality of discharge cells;
address electrodes arranged to correspond to the discharge cells;
phosphor layers arranged in each of the discharge cells to define the discharge cells into discharge cells of first, second, and third colors; and
scan electrodes and sustain electrodes intersecting the address electrodes and opposing each other in each of the discharge cells and adapted to form discharge gaps;
wherein the scan electrodes and sustain electrodes extend along one direction intersecting the address electrodes, each including a plurality of line sections spaced apart from one another, and a pair of connecting portions arranged in least one color discharge cell adjacent to a pair of barrier ribs defining the least one color discharge in a direction intersecting the plurality of line sections.

12. The PDP of claim 11, wherein the plurality of line sections formed along the third color discharge cell are connected to one another through the pair of connecting portions.

13. The PDP of claim 12, wherein the plurality of line sections formed along the first and second color discharge cells are connected to one another through one connecting portion.

14. The PDP of claim 13, wherein the connecting portions formed along the first and second color discharge cells are positioned toward the centers of the discharge cells.

15. The PDP of claim 11, wherein the connecting portions are spaced apart 40 to 50 μm from the phosphor layers arranged on the barrier ribs.

16. The PDP of claim 11, wherein the connecting portions are spaced apart 10 to 20 μm from the phosphor layers arranged on the barrier ribs.

17. The PDP of claim 11, wherein the scan electrodes and sustain electrodes each include first line sections extending along a direction intersecting the address electrodes, and second line sections spaced apart from the first line sections and positioned in each of the discharge cells to form the discharge gaps.

18. The PDP of claim 17, further comprising third line sections arranged between the first line sections and the second line sections.

19. The PDP of claim 18, wherein the first, second, and third line sections are parallel to one another.

20. The PDP of claim 17, wherein the discharge gaps include a first gap member and a second gap member, the first and second gap members having different lengths from each other.

21. The PDP of claim 20, wherein the second gap member is longer than the first gap member and arranged at interconnections where the second line sections and the connecting portions meet.

22. The PDP of claim 11, wherein the first and line sections and the connecting portions comprise thin, long strip-like thin films.

23. The PDP of claim 11, wherein the first and line sections and the connecting portions comprise chrome, copper or other metallic materials.

24. The PDP of claim 11, wherein the first, second, and third colors respectively comprise red, green, and blue.

25. The PDP of claim 12, wherein the first, second, and third colors respectively comprise red, green, and blue.

26. The PDP of claim 13, wherein the first, second, and third colors respectively comprise red, green, and blue.

27. The PDP of claim 14, wherein the first, second, and third colors respectively comprise red, green, and blue.
